(19) United States
(12) Patent Application Publication
(10) Pub. No.: US 2020/0036470 A1
(43) Pub. Date: Jan. 30, 2020

(54) COMMON CONTROL CHANNEL AND REFERENCE SYMBOL FOR MULTIPLE WAVEFORM DATA TRANSMISSION

(71) Applicant: IDAC HOLDINGS, INC., Wilmington, DE (US)

(72) Inventors: Robert L OLESEN, Huntington, NY (US); Rui YANG, Greenlawn, NY (US); Erdem BALA, East Meadow, NY (US); Alphan SAHIN, Westbury, NY (US); Moon-il LEE, Melville, NY (US); Kyle Jung-Lin PAN, Saint James, NY (US); Mihaela C BELURI, Jericho, NY (US)

(73) Assignee: IDAC Holdings, Inc., Wilmington, DE (US)

(21) Appl. No.: 16/337,375

(22) PCT Filed: Sep. 28, 2017
(86) PCT No.: PCT/US2017/053966

§ 371 Date: Mar. 27, 2019

Related U.S. Application Data
(60) Provisional application No. 62/400,994, filed on Sep. 28, 2016.

(51) Int. Cl. H04L 1/00; H04L 5/00; H04L 27/00; H04L 27/26

(52) U.S. Cl. CPC H04L 1/0025; H04L 1/0032; H04L 1/0033; H04L 27/2613; H04L 5/0048; H04L 27/0008; H04L 5/0007

(57) ABSTRACT

Systems, methods, and instrumentalities are disclosed for determining an uplink (UL) waveform type associated with a data symbol in an UL transmission, wherein the UL waveform type is determined based on a predefined condition, indicating the determined UL waveform type using symbols in a slot, and wherein the symbols comprise a reference signal of a first type, and wherein the symbols are prior to the data symbol in the slot, and transmitting, using the determined UL waveform type, the symbols comprising the reference signal of the first type and a data symbol.

### CROSS-REFERENCE TO RELATED APPLICATOINS

This application claims the benefit of 62/400,994, filed Sep. 28, 2016, the disclosure of which is hereby incorporated by reference in its entirety.

### BACKGROUND

Mobile communications continue to evolve. A fifth generation may be referred to as 5G, which may implement an advanced wireless communication system called New Radio (NR).

### SUMMARY

Systems, methods, and instrumentalities are disclosed for determining an uplink (UL) waveform type associated with a data symbol in an UL transmission, wherein the UL waveform type is determined based on a predefined condition, indicating the determined UL waveform type using symbols in a slot, and wherein the symbols comprise a reference signal of a first type, and wherein the symbols are prior to the data symbol in the slot, and transmitting, using the determined UL waveform type, the symbols comprising the reference signal of the first type and a data symbol.

### BRIEF DESCRIPTION OF THE DRAWINGS

A more detailed understanding may be had from the following description, given by way of example in conjunction with the accompanying drawings.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A.

FIG. 1C is a system diagram illustrating an example radio access network (RAN) and an example core network (CN) that may be used within the communications system illustrated in FIG. 1A.

FIG. 1D is a system diagram illustrating a further example RAN and a further example CN that may be used within the communications system illustrated in FIG. 1A .

FIG. 2 illustrates an example of transmitter and receiver structures for dynamic reference signal (RS) insertion.

FIG. 3 is an example of an interference cancellation (IC) block.

FIG. 4 is an example of multiplexing different types of symbols with Discrete Fourier Transform (DFT)-spread Orthogonal Frequency Division Multiplexing (DFT-s-OFDM).

FIG. 5 is an example of multiplexing different types of symbols with Orthogonal Frequency Division Multiplexing (OFDM).

FIG. 6 is an example of waveform independent reference signal transmission.

FIG. 7 is an example of reference signal generation with DFT spreading.

FIG. 8 is an example of indicating waveform type using reference signals.

FIG. 9 is an example of additional RSs to support high mobility.

FIG. 10 is an example of additional RSs using different numerology for the RSs.

FIG. 11 is an example of resource reservation for different waveforms.

FIG. 12 is an example of an RS design for phase tracking.

FIG. 13 is an example of multiplexing of symbols with different Cyclic Prefix (CP) lengths.

FIG. 14 is an example of Uplink (UL) ACK/NAK (A/N) and Uplink Control Information (UCI) feedback piggyback on physical uplink shared channel (PUSCH) using an OFDM waveform.

FIG. 15 is an example of time division multiplex (TDM) UL control and UL data in a transmission time interval (TTI) using DFT-s-OFDM for control.

FIG. 16 is an example of UL A/N feedback multiplexed UCI information.

FIG. 17 is an example of UL A/N feedback puncturing UCI information.

FIG. 18 is an example of UL A/N feedback puncturing data transmitted with OFDM.

FIG. 19 is an example of control channel transmission using reserved sub-carriers.

FIG. 20 is an example of transmitting DFT-s-OFDM based UL control in pre-defined control resources.

FIG. 21 is an example of TDM applied to UL control and UL data in a TTI using OFDM for control.

FIG. 22 is an example of multiplexing OFDM based UL control with DFT-s-OFDM based UL data.

FIG. 23 is an example of using OFDM for a control waveform in the absence of a UL grant.

FIG. 24 is an example of using a mixed numerology in the absence of a UL grant.

FIG. 25 is an example of determining a waveform type to use for data transmission based upon a predefined condition.

FIG. 26 is an example of an RS design for phase tracking.

### DESCRIPTION

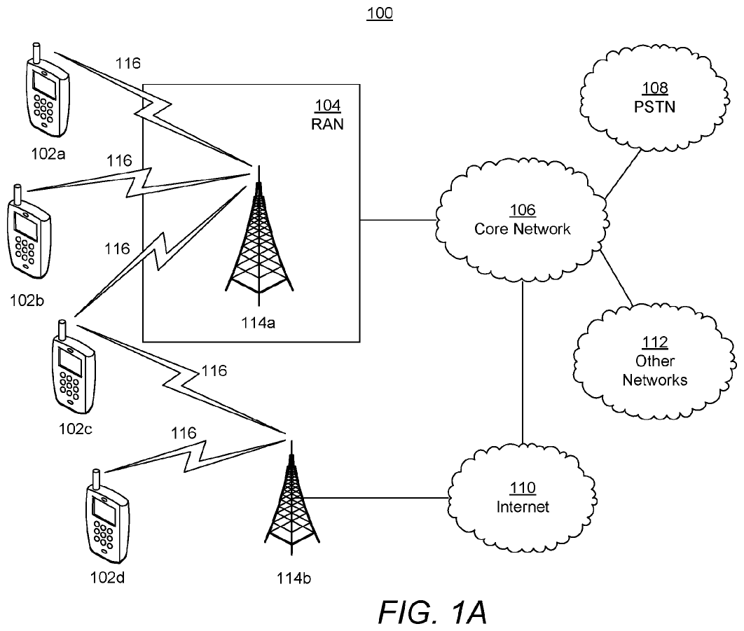

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 108a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

OFDM may be used for downlink (DL) transmission while DFT-s-OFDM may be used for uplink (UL) transmission (e.g. in LTE). A Cyclic Prefix (CP) DFT-s-OFDM (e.g. a single carrier (SC) SC-FDMA with multiple accessing) may spread data symbols with a DFT block and may map the data symbols to corresponding inputs of an IDFT block. A CP may be prepended to the beginning of a symbol, for example, to avoid inter-symbol interference (ISI) and to allow one-tap frequency domain equalization (FDE) at the receiver.

DFT-s-OFDM may be considered to be, for example, a precoded OFDM scheme where precoding with DFT may reduce PAPR. DFT-s-OFDM may be considered to be, for example, a scheme that upsamples data symbols by a factor equal to a ratio of IDFT and DFT block sizes and applies circular pulse shaping with a Dirichlet sinc function before a CP extension. DFT-s-OFDM may exhibit lower PAPR than CP-OFDM.

In an example of LTE uplink transmission, a (e.g. each) subframe (or TTI) may be partitioned into 14 symbols (e.g. including CP). System bandwidth may be shared by scheduled users for UL transmissions. Frequency domain resources (e.g. RBs) at the edges of system bandwidth may be used, for example, to transmit control channel (PUCCH) and its reference channel, PUCCH RS. The remainder may be used, for example, to transmit data channel (PUSCH) or reference channel (PUSCH RS). The 4th and 11th symbols may be dedicated, for example, to reference signals that may be used for channel estimation at the receiver.

In an example of LTE downlink transmission, reference symbols may be scattered over specific subcarriers, e.g., an OFDM symbol may have subcarriers loaded with data and reference symbols. Common reference symbols may be transmitted on subcarriers distributed over system bandwidth. WTRU-specific reference signals may be distributed over a subband allocated to a specific WTRU.

An advanced wireless communication system called New Radio (NR) may utilize OFDM (e.g. as a main waveform) for DL and UL transmissions, e.g., for below −40 GHz of carrier frequencies. DFT-s-OFDM may be supported for coverage limited WTRUs. A WTRU may be able to switch between OFDM and DFT-s-OFDM.

A WTRU (e.g. in NR) may be able to switch a UL waveform from OFDM to DFT-s-OFDM and vice versa. This and/or other waveform adaptations may increase system complexity, for example, when there may be separate designs of UL RSs and a control channel for each of multiple waveforms. UL reference signals and control channel may be common regardless of the waveform used for data transmission.

WTRUs that may transmit with different waveforms may be scheduled in multiuser MIMO mode, e.g., the WTRUs may transmit on the same time/frequency resources. WTRU transmissions may be separated at the receiver, for example, when the channels from these WTRUs may be estimated (e.g. reliably). A common reference signal design for different waveform candidates may enable reliable channel estimation.

A reference symbol may be used to denote a symbol, such as a complex number that may be fixed, known and used as a pilot. A reference signal may be used to denote a time domain signal that may be generated after processing reference symbols. For example (e.g. in OFDM), reference symbols may be complex numbers fed into an IDFT block. A reference signal may be an output of the IDFT block.

DFT-S-OFDM may be provided with frequency domain reference symbols. DFT output may be punctured to insert reference symbols.

A block of information symbols may be fed into a DFT block. The size of a DFT may be larger than the number of information symbols. The block of information symbols may be spread with the DFT matrix. Specific outputs of the DFT block may be punctured, e.g., zeroed out and replaced with reference symbols. The output may be mapped to the corresponding inputs of an IDFT block. An (e.g. each) input of the IDFT block may correspond to a specific subcarrier. Some of the subcarriers may be loaded with DFT-spread information symbols while some (e.g. other) subcarriers may be loaded with reference symbols. Subcarriers, or a subset thereof, may be loaded with reference symbols that may be known by the receiver, e.g., to facilitate channel, noise and/or phase estimation. Symbols may (e.g. before being mapped to the IDFT) be pre-processed, for example, with a frequency domain windowing operation.

The indices of subcarriers that may be used for reference symbol transmission may not change between waveforms, e.g., depending on the waveform. In an example, the same subcarriers may be loaded with reference symbols, for example, when OFDM or DFT-s-OFDM may be used for transmission. In an example, information symbols may not be spread (e.g. with a DFT block), for example, when OFDM may be used for transmission.

In an example, DFT-s-OFDM may be used as a waveform. The block of data symbols may be denoted as d=[d0 d1 d2 d3 d4 d5]. An input to DFT block may be di=[d0 d1 d2 d3 d4 d5 0 0]. An output of the DFT may be denoted as D=[D0 D1 D2 D3 D4 D5 D6 D7]. Selected outputs of the DFT (e.g. before being mapped to corresponding subcarriers) may be punctured and replaced with reference symbols, e.g., resulting in Dp=[R0 D1 D2 D3 R1 D5 D6 D7]. In an example, the 1st and 5th outputs of the DFT may be punctured and replaced with two reference symbols R0 and R1. The composite block Dp, that may be composed of DFT-spread information symbols and reference symbols may be mapped to corresponding inputs of the IDFT block.

OFDM may be used as a waveform. The same subcarriers may be used for transmission. Information symbols and RSs may be multiplexed, for example, so that RSs may be fed into the same inputs of the IDFT as the RSs for the DFT-s-OFDM. The input that may be mapped to the corresponding inputs of the IDFT may be Do=[R0 D0′ D1′ D2′ R1 D3′ D4′ D5′]. [D0′ D1′ D2′ D3′ D4′ D5′] may be equal to [d0 d1 d2 d3 d4 d5].

Puncturing and recovery of data may be achieved with DFT-s-OFDM.

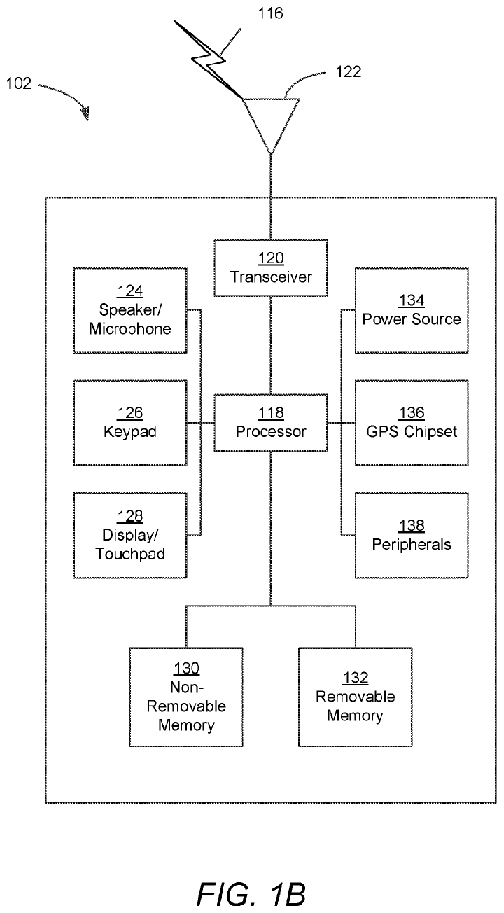

FIG. 2 is an example of transmitter and receiver structures for dynamic RS insertion.

In an example, a transmitter (e.g. WTRU) may have K DFT blocks, each with size M. DFT blocks may have different sizes. KM_2 reference symbols (or pilots) may be transmitted in the frequency domain, e.g., at the input of IDFT operation. In an example, the M_2 input of the DFT block may be zeroes and the M_1 input may be modulated data symbols, e.g., where M_1+M_2=M. The locations of the zero symbols and the data symbols may be randomized. The location of the zero samples may be chosen, for example, so that the receiver observes at least M_3+1 samples. At the output of each DFT block, every other M_3 samples may be discarded and replaced by the reference symbols, e.g., where M_3=M_1/M_2. The new vector may be fed to the input of the IDFT block. For example, M=8 and M_2=2 reference symbols {r_1,r_2} may be used for 8 subcarriers. The input of the DFT block may be selected to be {d_1,d_2, . . . ,d_6,0,0}. In an example, M_1=6. The output of DFT may be {x_1,x_2, . . . , x_8}. Every M_3=4 DFT outputs may be discarded and replaced by {r_1,r_2}. The result may be {r_1,x_2,x_3,x_4,r_2,x_6,x_7,x_8}, which may be fed to the IDFT block to generate time domain signals.

In an example, e.g., as shown in FIG. 2, M=M_1+M_2, M_3=M/M_2−1 and M_1=M_2 M_3.

Signal processing at a receiver (e.g. up to IDFT operation) may be similar (e.g. the same as) receiver operation for DFT-s-OFDM signals. Subcarriers that may carry reference signals at the output of DFT blocks may be used for channel estimation. Subcarriers at a receiver DFT output corresponding to subcarriers that may be discarded and not replaced by a reference signal (e.g. replaced by zeros) at the transmitter side may be used for noise or interference power estimation.

Some DFT block outputs may be replaced by reference symbols at the transmitter side. The output of IDFT at a receiver side may have interference due to a puncturing operation. Interference may be recovered from M_2 outputs of IDFT blocks and may be used to remove interference at other outputs of IDFT blocks. This process may be performed in interference cancellation (IC) blocks, for example, as shown in FIG. 2 at (b).

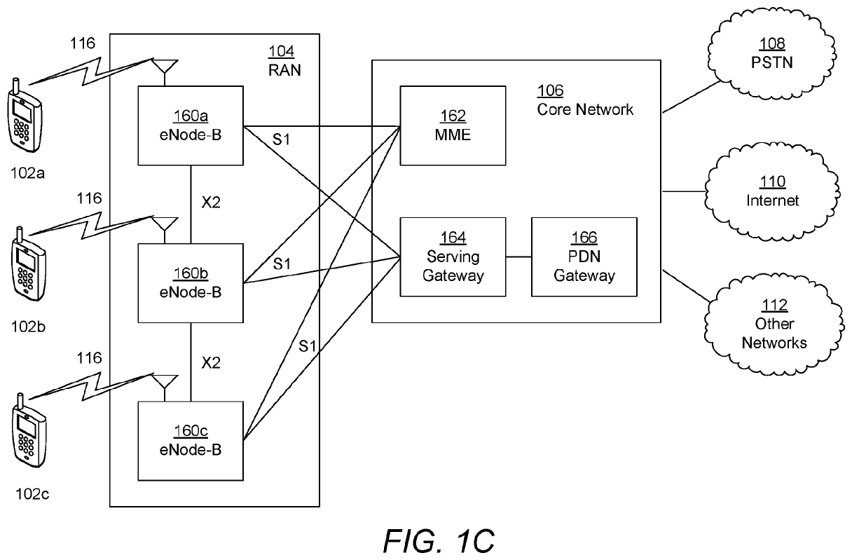

FIG. 3 is an example of an IC block. In an example, the structure of an IC block may be provided for a zero offset (e.g. S=0). An IC block may have an iterative receiver architecture.

A waveform structure used for transmission may be known at a receiver. A procedure at a receiver (e.g. WTRU) may be used to determine which waveform was used for transmission. The procedure may be implemented prior to a channel estimation procedure. In an example, a common control channel and/or control information symbols may be used to convey to a receiver an indication of a waveform used for transmission. In an (e.g. alternative) example, a waveform used for transmission may be determined implicitly. For example, a subset of RSs may be used to indicate to a receiver which waveform will be, is and/or was used for transmission.

DFT output may be multiplexed with reference signals. The output of the DFT block may be multiplexed with reference symbols and/or control information symbols, e.g., before being mapped to corresponding inputs of an IDFT block. Multiplexing may be performed in a variety of ways, for example, so that a (e.g. one) DFT-s-OFDM symbol may consist of: (i) only user data (e.g. only output of the DFT block may be selected and mapped to corresponding inputs of the IDFT block); (ii) only reference symbols (e.g. only reference symbols may be selected and mapped to corresponding inputs of the IDFT block) or (iii) data and reference symbols (e.g. output of the DFT block and reference symbols may be multiplexed and mapped to corresponding inputs of the IDFT block).

Control information symbols may be (e.g. similarly) multiplexed with user data and/or reference symbols before being mapped to corresponding inputs of the IDFT block.

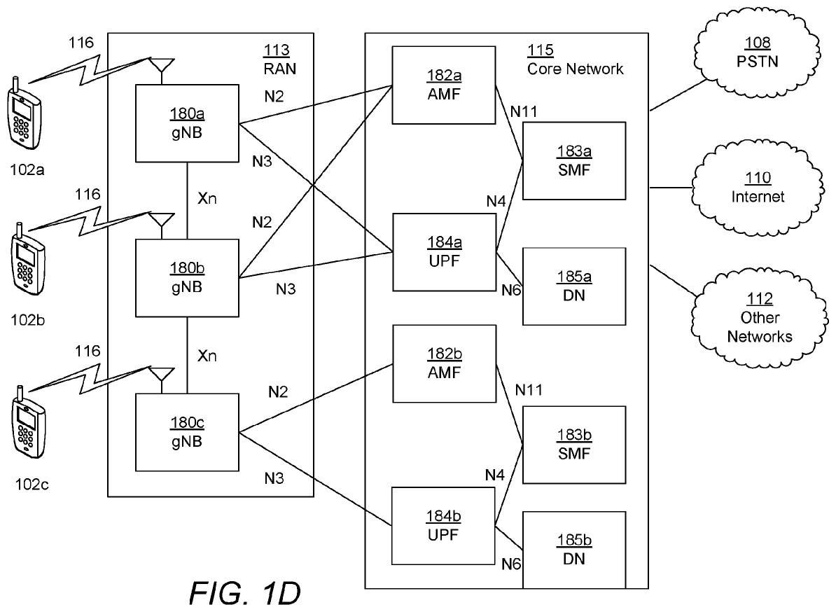

FIG. 4 is an example of multiplexing different types of symbols with DFT-s-OFDM. FIG. 4 (left) shows an example where data may be spread with DFT processing. Spread data, reference symbols, and control information symbols may be multiplexed by selecting desired symbols. Selected symbols may be mapped to corresponding inputs of an IDFT block. Control information symbols and/or reference symbols may (e.g. also) be precoded, for example, with a DFT spreading block. Data may consist of user data, control data and/or other types of data. A cyclic prefix may be appended to the output of the IDFT. The signal may be shaped by applying, for example, filtering and/or windowing, e.g., before being further processed for transmission.

FIG. 4 (right) shows examples of a time/frequency representation of various signals. A (e.g. each) rectangle may illustrate a DFT-s-OFDM symbol in time and a subcarrier in frequency. In the top example shown in FIG. 4 (right), the first DFT-s-OFDM symbol may contain (e.g. only) control data while the following DFT-s-OFDM symbols may contain user data and reference symbols. In the bottom example shown in FIG. 4 (right), user data and reference symbols may be transmitted in different DFT-s-OFDM symbols (e.g., control, reference, then data over time).

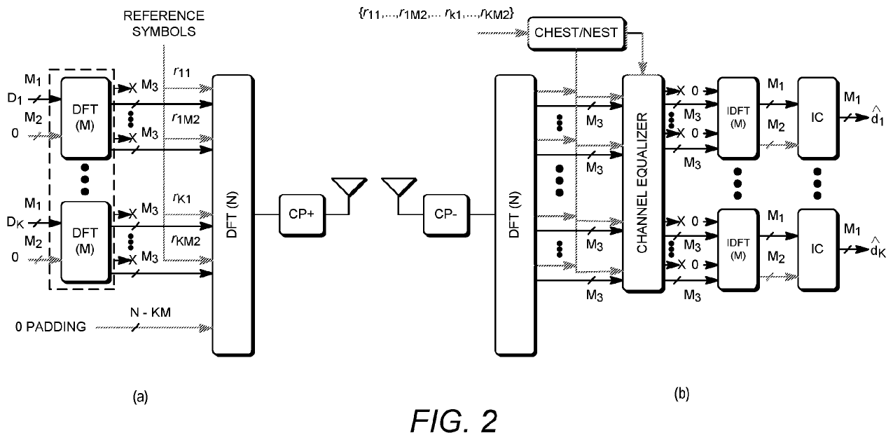

FIG. 5 is an example of multiplexing different types of symbols with OFDM. The same or a similar approach discussed with regard to FIG. 4 may be used for OFDM to transmit reference symbols and/or control information. In an example with OFDM, user data may not be precoded with a DFT spreading block, e.g., as illustrated in the example shown in FIG. 5.

A reference signal (RS) may be waveform independent. A reference signal may be generated with a preferred waveform. The reference signal may be used to transmit the reference symbols, e.g., regardless which waveform may be used for data transmission. A reference signal may be time-multiplexed with other OFDM, DFT-s-OFDM and/or other waveform type symbols.

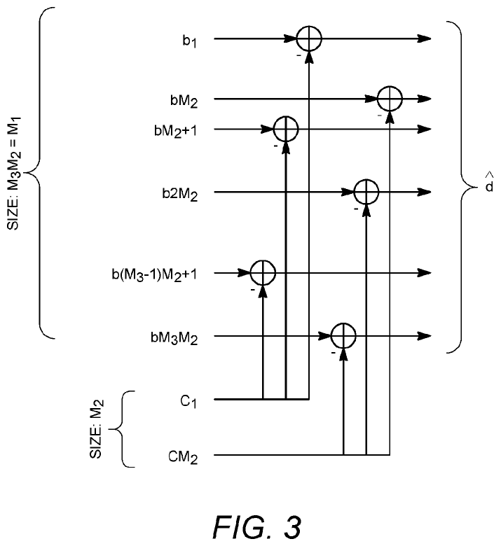

FIG. 6 is an example of waveform independent reference signal transmission. FIG. 6 illustrates an example of multiplexing a reference signal with other symbols. In an example of DL or UL reference signal generation, (e.g. only) subcarriers allocated to a WTRU may be utilized.

In an example of RS generation, a block of reference symbols may be precoded with a DFT spreading block and mapped to scheduled subcarriers. A length of the DFT size may be M, for example, when the number of scheduled subcarriers may be M.

In an example of RS generation, a block of reference symbols may be repeated n times, for example, before being processed by a DFT block, e.g., so the output of the DFT block may have zeros at every nth output pin. The output of the DFT block may be fed into corresponding inputs of an IDFT block.

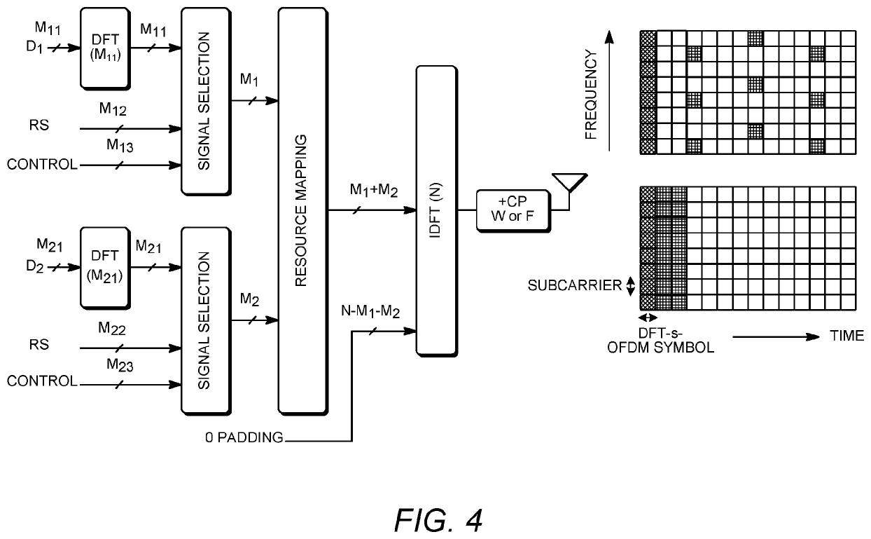

FIG. 7 is an example of reference signal generation with DFT spreading. In an example, e.g., as shown in FIG. 7, n=2.

In an example of RS generation, a block of reference symbols may be interleaved and fed into a DFT block. The output may be fed into corresponding inputs of an IDFT block. The IDFT size may be M and the length of the reference symbol block may be K. In an example, reference symbols may be mapped to inputs of a DFT block with indices i=0+(M/K)j, j=1, . . . ,K.

Reference symbols may be known and fixed. A reference signal may be precomputed and transmitted without computing DFTs every time the reference signal has to be transmitted.

One or more waveforms may be used for a data transmission and a WTRU may determine a waveform for a data transmission (e.g., PUSCH) based on at least one of channel condition, scheduling parameters, and/or power headroom. For example, a first waveform (e.g., CP-OFDM) may be used when a WTRU has enough power for a PUSCH transmission and a second waveform (e.g., DFT-s-OFDM) may be used when a WTRU reached maximum transmission power. The waveform determined for a PUSCH transmission may be indicated with RSs, wherein the RSs may be an associated demodulation RS (DM-RS) for the PUSCH transmission. For example, a sequence and/or locations of the RSs may indicate the determined waveform for the uplink transmission.

The selected or determined waveform type may be indicated by reference signals that may be transmitted, e.g., before data transmission commences. For example, the associated DM-RS for a PUSCH may be located at the front of the slot for a PUSCH transmission and commonly used for one or more waveforms and a sequence (e.g., cyclic shift of an RS, scrambling code, or sequence type), pattern (set of subcarriers), or location (e.g., OFDM or DFT-s-OFDM symbol location) of the associated DM-RS may be determined based on the selected or determined waveform type for a PUSCH transmission. For example, a Zadoff-Chu sequence may be mapped to allocated subcarriers to generate a reference signal.

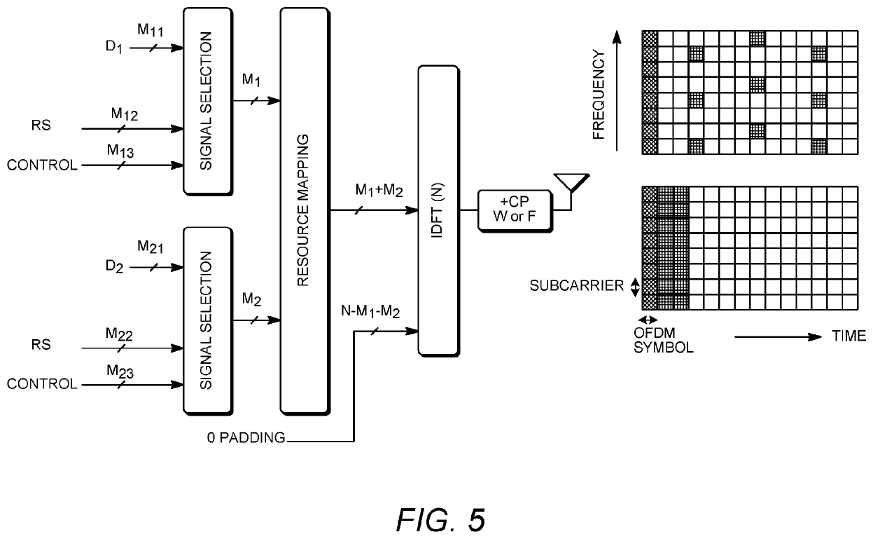

FIG. 8 is an example of indicating waveform type (e.g., OFDM or DFT-s-OFDM) using reference signals. A transmitting entity, such as a WTRU, may determine a waveform type for transmission (e.g., data transmission), for example as described herein. In an example, the waveform type may be signaled, for example, by applying a time domain orthogonal cover code over multiple reference signals, where a receiving entity may determine the waveform type from the signaling. For example, e.g., as illustrated in FIG. 8, two reference signals may be multiplied by [1 1] or [1 −1], where [1 1] may indicate one waveform type while [1 −1] may indicate another waveform type. Also as illustrated in FIG. 8, the reference signals (e.g., the reference signals coded by multiplication) may be sent before the data symbols.

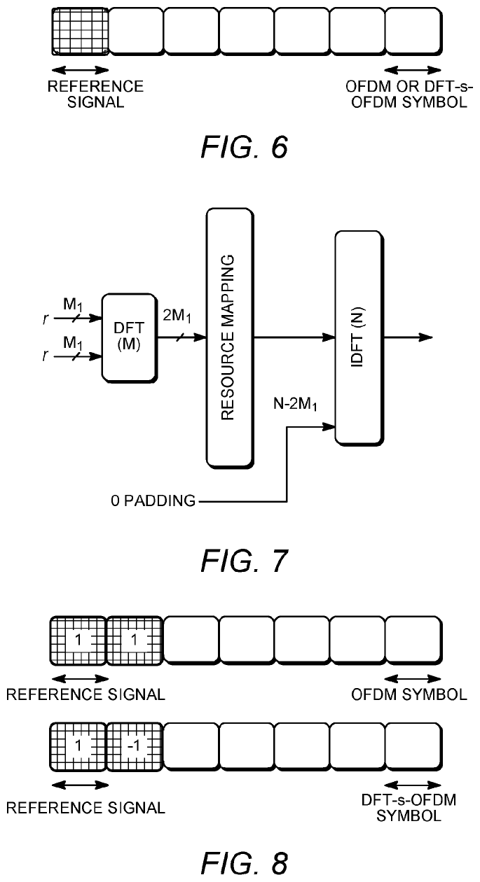

A reference signal design may be implemented for high mobility. For example, high mobility may employ additional reference symbols, e.g., to better track the channel. The additional reference signals may be inserted as described herein. FIG. 9 is an example of additional RSs to support high mobility. For example, FIG. 9 at (a) depicts control information and reference symbols transmitted before the data symbols. FIG. 9 at (b) depicts additional reference symbols inserted into selected subcarriers. FIG. 9 at (c) depicts a (e.g., one) whole OFDM or DFT-s-OFDM symbol used as an additional reference signal.

The additional RSs may be turned on (e.g., or off) by signaling using the control channel. For example, in the downlink transmission, the control channel may indicate if the additional reference symbols have to be turned on or off. For example, in the uplink transmission, the grant and/or control channel may indicate if the following uplink transmission should have the additional reference symbols turned on or off.

A WTRU may autonomously turn the additional RSs on or off. A WTRU may signal the status (turned on or off) in a control channel in the UL transmission. A WTRU may indicate this implicitly. For example, a first RS (e.g., located at the front of PUSCH transmission) may be the same irrespective of the additional RSs on or off and a sequence, pattern, and/or location of the first RS may indicate the presence/absence of the additional RS. A WTRU may determine the transmission of an additional RS based on at least one of channel condition, scheduling parameter (e.g., MCS level), and mobility and the WTRU may indicate the determined condition of presence or absence of an additional RS (e.g., on or off) by determining a sequence, pattern, and/or location of the first RS. A determination of the status of the additional RSs (e.g., on or off) may be determined, e.g., using blind detection.

A reference signal may have different numerology. The time density of reference symbols may be increased, for example, by distributing shorter reference signals among data symbols. A data symbol may be generated, for example, with OFDM, DFT-s-OFDM or another OFDM based waveform. A reference signal may be common (e.g. to both or all), for example, when there is more than one waveform. Shorter reference signals may be generated, for example, by using a different numerology than the data transmission. In an example, a reference signal that is half duration of a data OFDM symbol may be generated, for example, by reducing the IDFT size by ½.

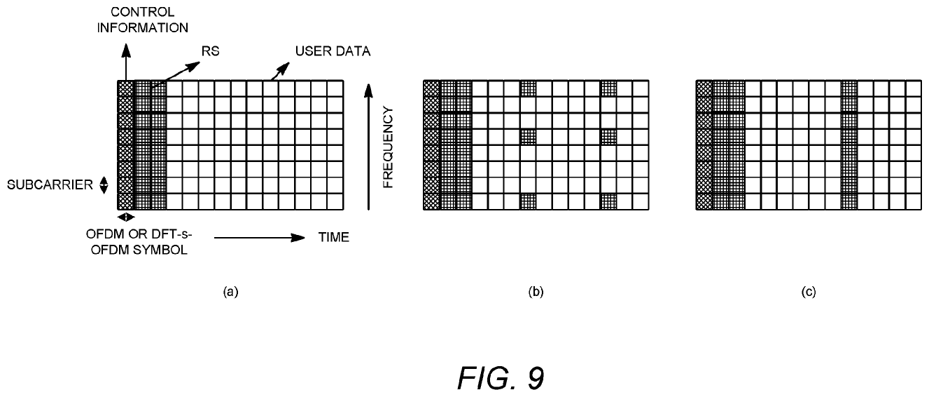

FIG. 10 is an example of additional RSs using different numerology for the RSs. FIG. 10 at (a) illustrates an example of an original arrangement and FIG. 10 at (b) illustrates an example where one of the OFDM or DFT-s-OFDM symbols may be removed and replaced by two reference signals. In an example, a (e.g. each) reference signal may have half the duration of an OFDM/DFT-s-OFDM symbol and twice the subcarrier spacing.

Resources may be allocated for different waveforms. In an example, time and frequency resources may be reserved, e.g., to be used with a specific waveform. Resources reserved for different waveforms may be multiplexed in time and/or frequency.

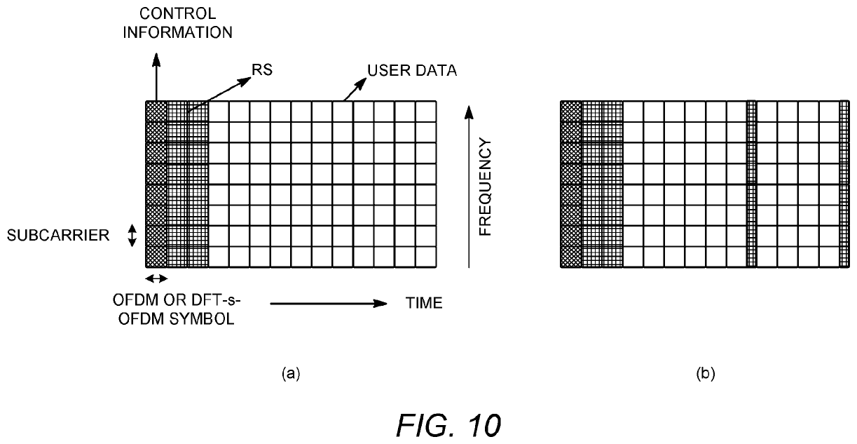

FIG. 11 is an example of resource reservation for different waveforms. FIG. 11 illustrates an example where resources reserved for different waveforms may be multiplexed in time and frequency. Reference signal design for each waveform may be optimized, for example, when resources reserved for each waveform may be different. Resources for a (e.g. each) waveform may be configured, for example, semi-statically, e.g., by a central controller.

A combination of a waveform common RS and a waveform dependent RS may be provided. A common RS may facilitate long term channel state information. A waveform dependent RS may facilitate short term channel state information. Other combinations may be implemented.

Additional time domain RSs may be provided, e.g., for phase tracking. Phase tracking may be achieved utilizing reference symbols. Phase tracking may be performed on a per OFDM, DFT-s-OFDM and/or other OFDM based waveform symbol basis. Reference symbols may exist in each of these symbols. Reference symbols (e.g. for DFT-s-OFDM) may be distributed (e.g. uniformly interleaved) among data symbols. A composite block of symbols may be spread with a DFT block. An example block, {ro, d1, d2, d3, r1, d4, d5, d6, r2, d7, d8, d9} may contain data symbols d and reference symbols r.

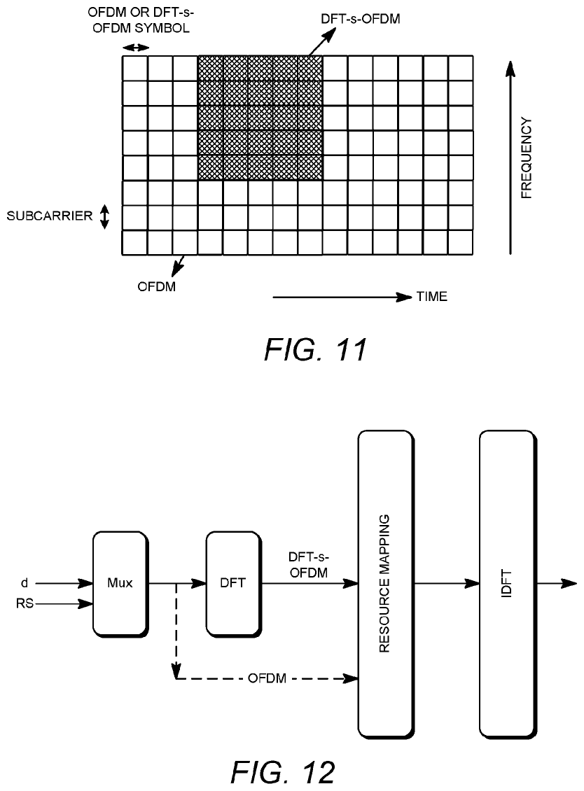

FIG. 12 is an example of an RS design for phase tracking. Data symbols and reference symbols may be multiplexed (e.g. first). An output of the multiplexer may be fed into a DFT block (e.g. before being mapped to corresponding inputs of an IDFT) or may be directly mapped to the IDFT input (e.g. skipping a DFT spreading operation). The first path may generate a DFT-s-OFDM waveform while the second path may generate an OFDM symbol.

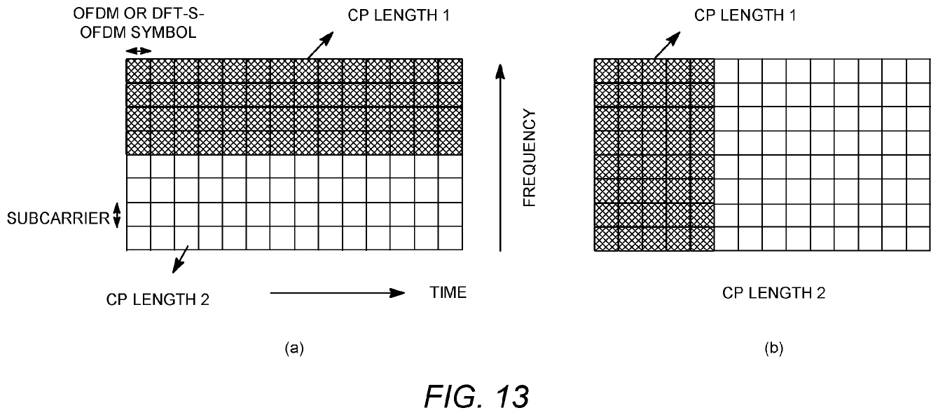

Multiplexing of symbols with different Cyclic Prefix (CP) lengths may be implemented. The CP length may be changed (e.g., adaptively changed) for DL or UL transmission. For example, in the DL direction, waveforms with different CP lengths may be multiplexed in time and/or frequency. FIG. 13 at (a) depicts multiplexing of OFDM and/or DFT-s-OFDM symbols with two CP lengths in frequency. FIG. 13 at (b) depicts multiplexing of OFDM and/or DFT-s-OFDM symbols with two (e.g., different) CP lengths in time. For example, in the UL direction, WTRUs may transmit with WTRU-specific CP lengths. A CP-length may (e.g., may also) be specific to the waveform type that is used for transmission.

A default CP length may be indicated in a common control channel, such as, for example, the broadcast channel. A WTRU may first read the common control channel and learn the length of the CP (e.g., and other relevant information). The initial transmission to and from this WTRU may use the default DL and UL CP lengths. After the connection is set up and measurements required to set the CP lengths are performed and reported, the CP length may be changed (e.g., dynamically or semi-statically). For example, dynamic CP length indication may be transmitted in the control channel and this indication may be valid for N sub frames, where the number N may be configured or signaled in the same control channel.

An uplink control channel may be provided for dynamic simultaneous operation of an OFDM and DFT-s-OFDM waveform. A WTRU (e.g. for UL transmissions) may be configured by an eNB to use a different waveform, for example, as a function of coverage. A WTRU may be configured to use DFT-s-OFDM for data transmissions, for example, when WTRU is coverage limited. A WTRU may be configured for OFDM for data transmissions, for example, when the WTRU is in good channel conditions. Other selections may be implemented, for example, when more than two OFDM based waveforms may be supported. Seamless coexistence may be provided between different waveforms for uplink transmissions. An uplink control channel may be agnostic to the waveform used for data channel transmission.

A UL control channel (e.g., PUCCH) may be transmitted with a first waveform (e.g. “control” waveform), and a UL data channel (e.g., PUSCH) may be transmitted with a second (different) waveform (e.g. “data” waveform). In an example, a control waveform may be the same for multiple (e.g. all) WTRUs, while a data waveform may be different for multiple (e.g. all) WTRUs, for example, as a function of channel conditions (e.g. depending whether a WTRU is in a coverage limited scenario). Waveform parameters (e.g. numerology) may (e.g. also) be different for a “control” waveform and a “data” waveform.

UL A/N and UCI feedback may piggyback on PUSCH, for example, using an OFDM waveform. A WTRU may be configured to transmit Uplink Control Information (UCI) feedback (e.g. CQI/PMI/RI) and UL ACK/NAK (A/N) feedback, for example, when it may be scheduled for UL data transmissions. A WTRU may be configured to use OFDM for the data waveform.

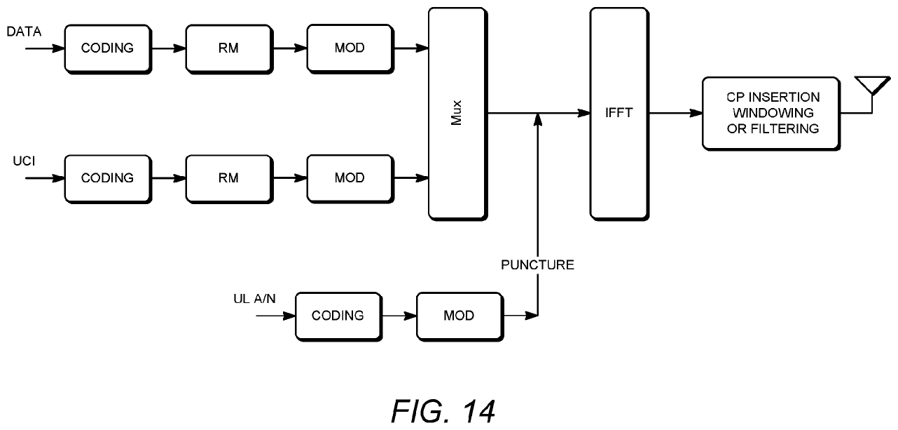

FIG. 14 is an example of UL A/N and UCI feedback piggyback on PUSCH using an OFDM waveform. In an example (e.g. as shown in FIG. 14), a UCI (e.g. CQI/PMI/RI) may be multiplexed with the PUSCH and UL A/N feedback may puncture the resources prior to the IFFT.

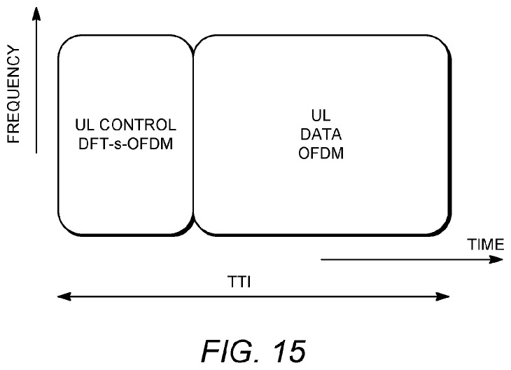

UL control may be based on time division multiplexing DFT-s-OFDM and UL data may be based on OFDM. In an example, PUCCH and PUSCH may be time division multiplexed in the same TTI. PUCCH may be transmitted with a first waveform (e.g. a “control” waveform) and PUSCH may be transmitted with a second (e.g. different) waveform (e.g. a “data” waveform). An eNB may configure a WTRU to use OFDM or DFT-s-OFDM for a data waveform, for example, based on whether the WTRU is in a power limited condition (e.g., use DFT-s-OFDM is the WTRU is in a power limed condition). A control waveform may be the same, for example, regardless of the waveform selected for data. For example, PUCCH may (e.g. always) be transmitted with DFT-s-OFDM and PUSCH may be transmitted with OFDM, e.g., when in good channel conditions, or with DFT-s-OFDM, e.g., when in power limited conditions, e.g., as shown in the example illustrated in FIG. 15.

FIG. 15 is an example of TDM UL control and UL data in a TTI using DFT-s-OFDM for control.

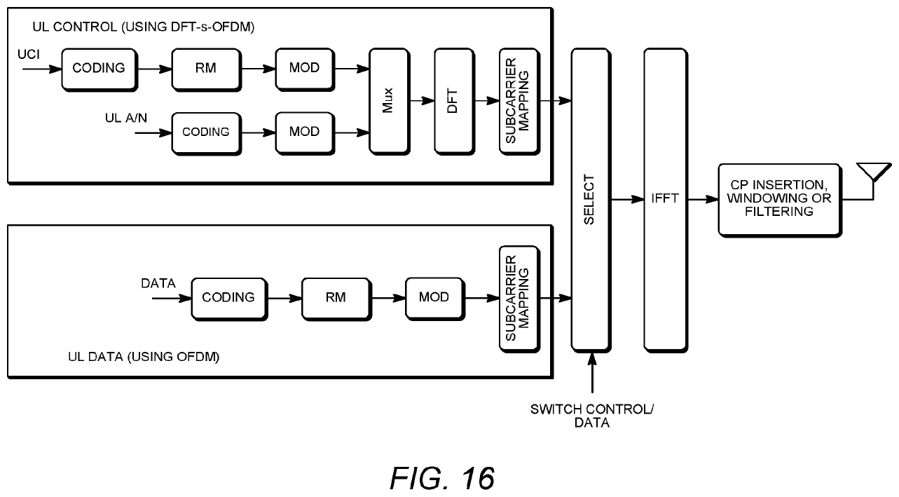

UCI information (e.g. CQI/PMI/RI) may be mapped to the beginning of a TTI. UL A/N feedback may be multiplexed with UCI information and transmitted in the control part of a TTI, for example, using a fixed waveform, e.g., as shown in the example illustrated in FIG. 16.

FIG. 16 is an example of UL A/N feedback multiplexed UCI information.

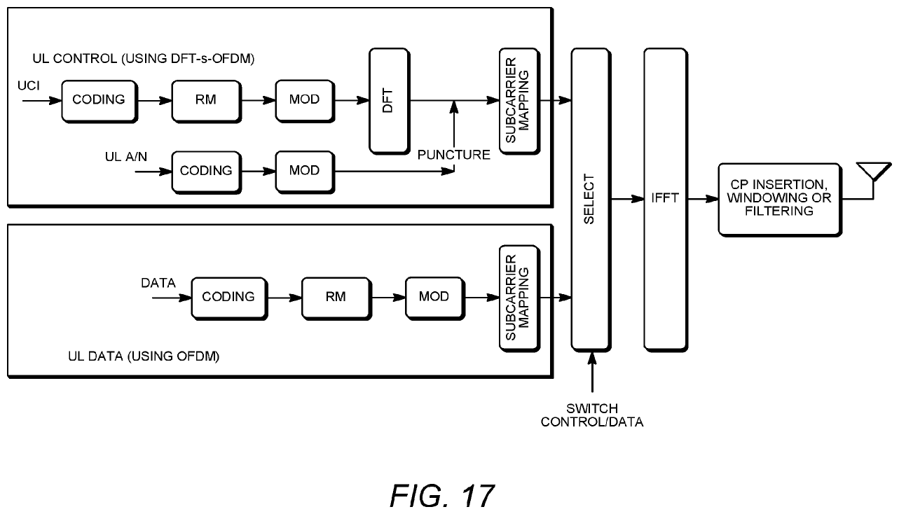

In an (e.g. another) example, UL A/N feedback may puncture UCI information and may be transmitted in a control part of a TTI, for example, using a fixed waveform, e.g., as shown in an example illustrated in FIG. 17.

FIG. 17 is an example of UL A/N feedback puncturing UCI information.

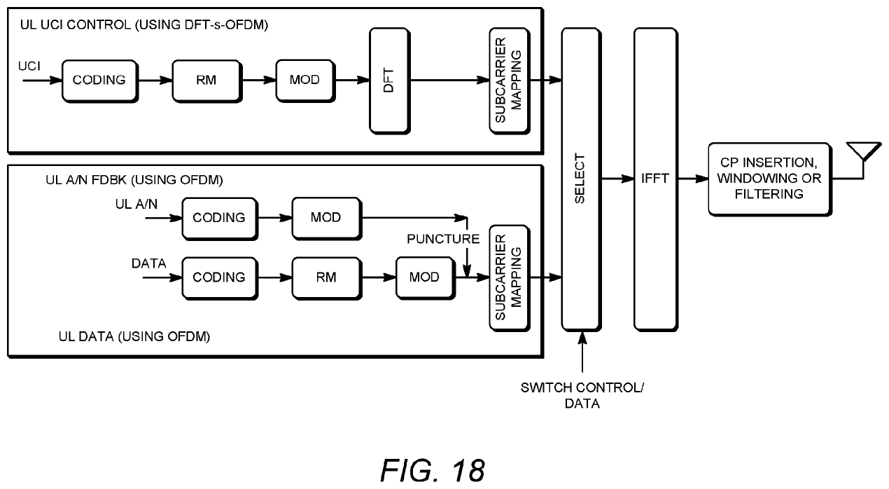

In an (e.g. another) example, UL UCI feedback may be transmitted using a fixed “control waveform” and UL A/N feedback may puncture data symbols transmitted with the “data” waveform, e.g., as shown in an example illustrated in FIG. 18.

FIG. 18 is an example of UL A/N feedback puncturing data transmitted with OFDM. This may avoid puncturing the UCI.

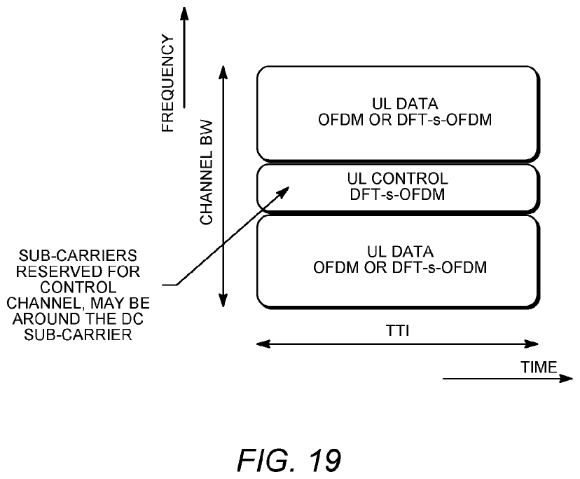

DFT-s-OFDM based UL control may be transmitted in pre-defined control resources. In an example, a set of sub-carriers may be reserved (e.g. around the DC sub-carrier) for control channel transmission. WTRUs may (e.g. using sub-carriers reserved for control) transmit a control channel using a “control” waveform (e.g. DFT-s-OFDM). A data channel may be transmitted using a “data” waveform (e.g. OFDM) on non-reserved sub-carriers, e.g., as shown in an example illustrated in FIG. 19.

FIG. 19 is an example of control channel transmission using reserved sub-carriers.

In an example, WTRUs (e.g. that may be in power limited conditions) may transmit UL control using DFT-s-OFDM on reserved sub-carriers (e.g. center sub-carriers) and may transmit UL data using DFT-s-OFDM on non-reserved subcarriers in the same OFDM symbol.

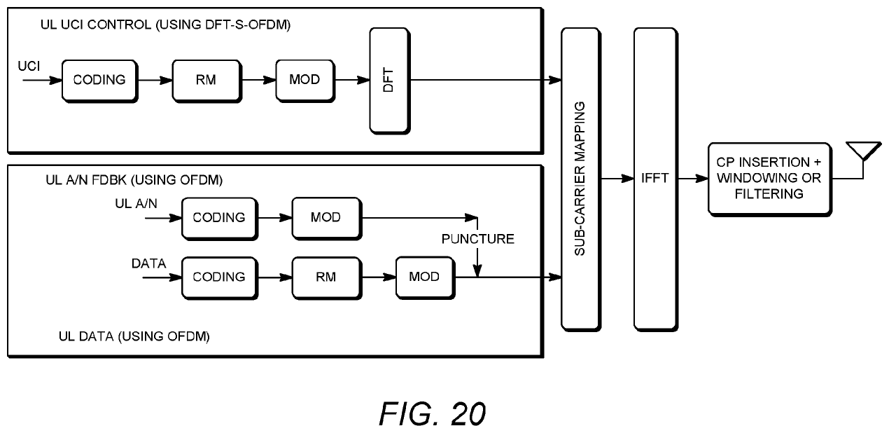

In an example, WTRUs (e.g. that may not be power limited) may use DFT-s-OFDM for control channel transmission on reserved sub-carriers and may use OFDM for data transmission on non-reserved sub-carriers, e.g., as shown in an example illustrated in FIG. 20.

FIG. 20 is an example of transmitting DFT-s-OFDM based UL control in pre-defined control resources.

In an example, WTRUs (e.g. that may be power limited) may transmit (e.g. only) control information, for example, using DFT-s-OFDM on reserved subcarriers in a given OFDM symbol. WTRUs may time multiplex the OFDM symbols that may carry control information and user data.

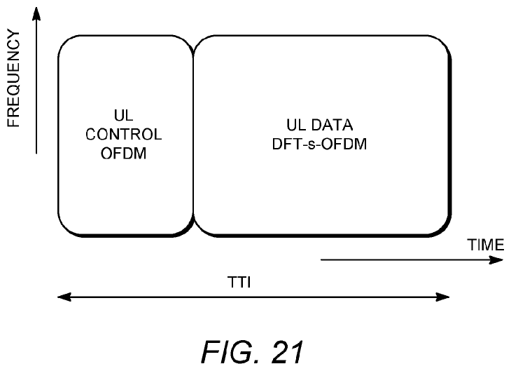

OFDM based UL control may be multiplexed with DFT-s-OFDM based UL data. In an example, PUCCH may (e.g. always) be transmitted with OFDM and PUSCH may be transmitted with OFDM (e.g. when in good channel conditions) or with DFT-s-OFDM (e.g. when in power limited conditions), for example, as shown in an example illustrated in FIG. 21.

FIG. 21 is an example of TDM applied to UL control and UL data in a TTI using OFDM for control.

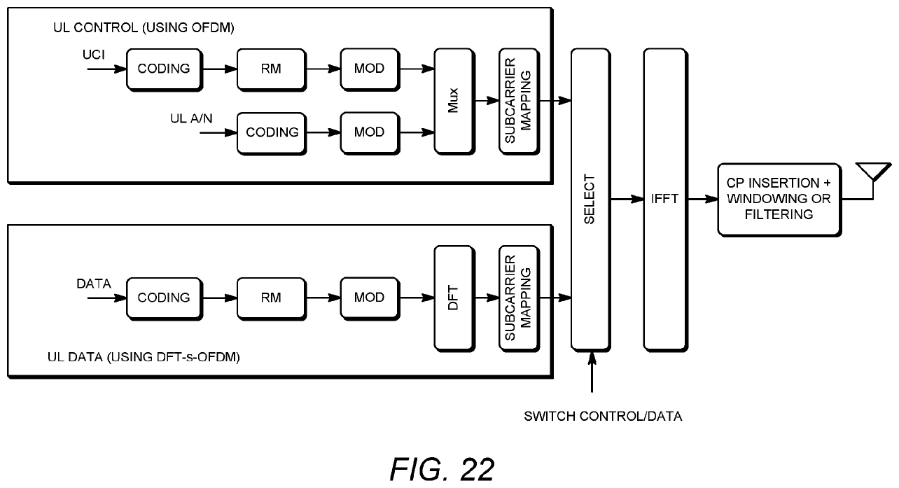

In an example, UL A/N may be multiplexed with a UCI (e.g. CQI/PMI/RI or other) and transmitted in a control part of a sub-frame using a “control” waveform (e.g. OFDM) and data may be transmitted in a data part of a (e.g. the) sub-frame using a “data” waveform (e.g. DFT-s-OFDM), for example, as shown in an example illustrated in FIG. 22.

FIG. 22 is an example of multiplexing OFDM based UL control with DFT-s-OFDM based UL data.

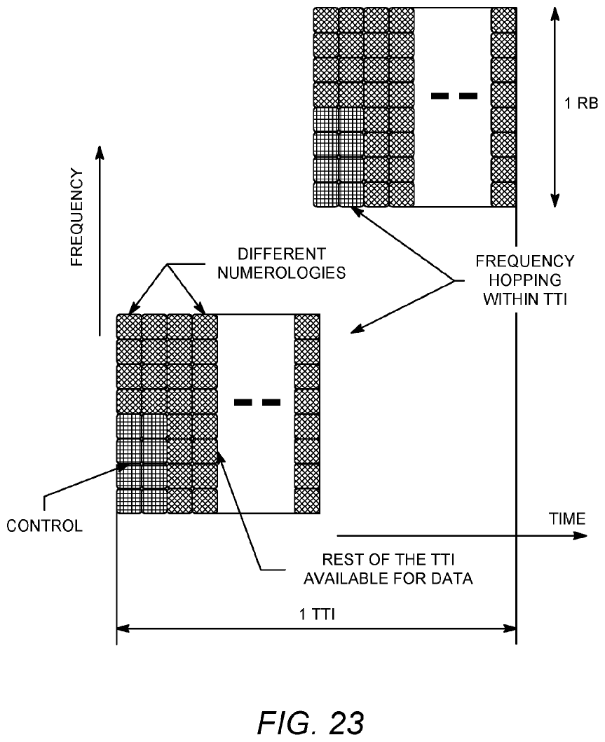

UL control channel transmission may be provided in the absence of UL grants. A WTRU may be configured to transmit UCI feedback (e.g., CQI/PMI/RI), as well as UL A/N feedback, when it may not be scheduled for UL data transmissions. An existing UL control channel is designed to minimize the PAPR, and thus it may assume the use of DFT-s-OFDM as a UL waveform. An existing UL control channel may use an entire RB (e.g., spanning a full TTI in time domain) for resources. Implementations described herein may improve the system efficiency of the transmissions of UL UCI and A/N transmissions in the absence of UL grants. For example. a WTRU may be configured to use OFDM for the control waveform, and map the UCI and A/N information to the OFDM symbols at the beginning of the TTI, while the remaining resources may be used for data transmission, as shown in FIG. 23.

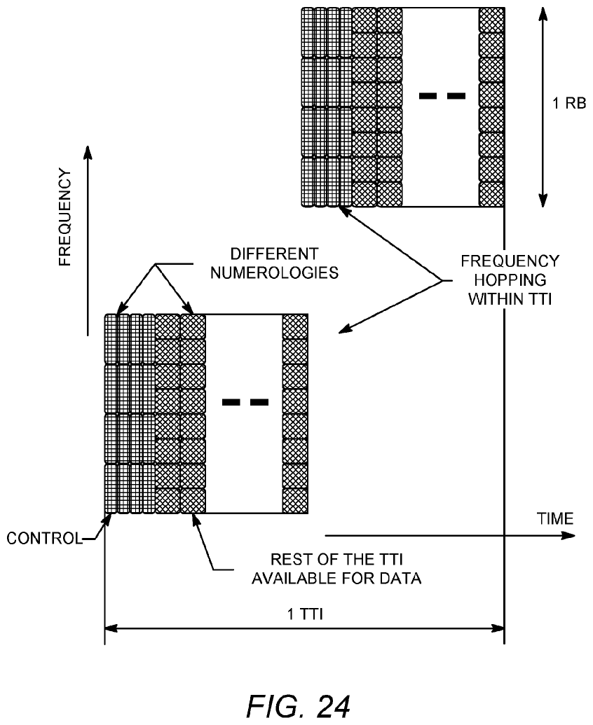

In examples, a WTRU may be configured to use OFDM as channel waveform, with mixed numerology, for example to use larger subcarrier spacing and shorter OFDM symbol length, for the control part. The UCI and/or A/N feedback may be coded (to provide coding gain) and mapped to several short OFDM symbols at the beginning of the TTI, as shown in FIG. 24. The transmission may also use frequency hopping within the TTI (e.g. for frequency diversity gain).

A WTRU may be configured to use a wider sub-carrier spacing for the control waveform, for example to reduce the PAPR and enable the WTRU to use higher transmit power, which may be useful to increase the coverage of the UL control channel.

Systems, methods, and instrumentalities have been disclosed for a common control channel and reference symbol for multiple waveform data transmission. A common reference signal (RS) may be provided for OFDM and DFT-s-OFDM. DFT output may be punctured or multiplexed with an RS. An RS may be waveform independent. An additional RS may be provided for mobility and phase tracking. Common control may be provided for OFDM and DFT-s-OFDM. UL A/N and UCI feedback may be piggybacked, for example, on PUSCH, e.g., using an OFDM waveform. DFT-s-OFDM or OFDM based UL control may be multiplexed with OFDM or DFT-s-OFDM based UL data. UL control channel transmission may be provided in the absence of UL grants.

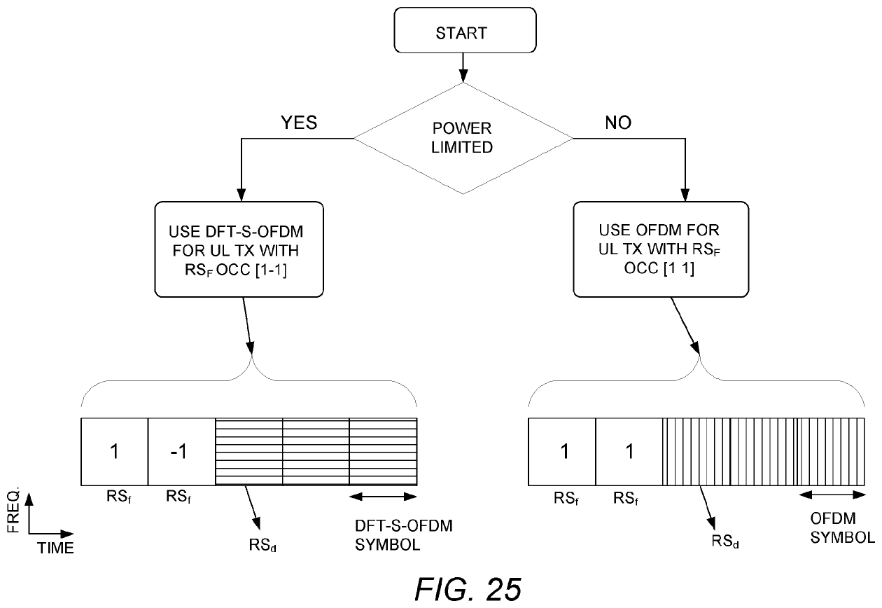

FIG. 25 is an example of determining a waveform type to use for data transmission based upon a predefined condition. An uplink (UL) waveform type to be used for data symbols in an UL transmission is determined based on a predefined condition. The determined UL waveform type is indicated using a reference signal in a slot prior to the data symbols. The reference signal and data symbols are transmitted with the determined UL waveform type.

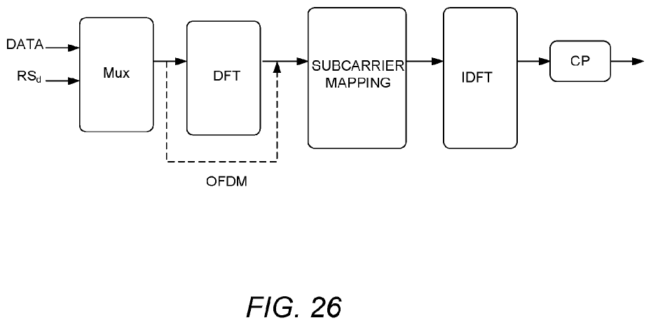

FIG. 26 is an example of an RS design for phase tracking.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer. Although features and elements of the present specification may consider LTE, LTE-A, New Radio (NR), or 5G specific protocols, it is understood that the solutions described herein are not restricted to these scenario(s) and may be applicable to other wireless systems as well.

1. A wireless transmit/receive unit (WTRU), comprising:
a memory;
a processor configured to:
determine a waveform type associated with a data symbol, wherein the waveform type is determined based on a predefined condition, and
indicate the determined waveform type using a plurality of symbols in a slot, wherein the plurality of symbols carries a set of reference signals of a first type; and
a transceiver configured to transmit the plurality of symbols and the data symbol,
wherein the data symbol is transmitted in the slot, using the determined waveform type and after the plurality of symbols is transmitted.

2. The WTRU of claim 1, wherein the predefined condition is any of a power limited condition or a mobility condition.

3. The WTRU of claim 1, wherein the processor is configured to apply one or more a-time domain orthogonal cover codes to the set of reference signals.

4. The WTRU of claim 3, wherein the set of reference signals includes two reference signals, wherein the one or more time domain orthogonal cover codes include a time domain orthogonal cover code being [1 1] or [1 −1], wherein [1 1] indicates a first waveform type and [1 −1] indicates a second waveform type.

5. The WTRU of claim 1, wherein the determined waveform type is any of: an Orthogonal Frequency Division Multiplexing (OFDM) waveform, or a Discrete Fourier Transform (DFT)-spread OFDM (DFT-s-OFDM) waveform.

6. The WTRU of claim 1, wherein the transceiver is further configured to transmit a set of reference signals of a second type.

7. The WTRU of claim 1, wherein the determined waveform type is a first waveform type multiplexed in time or a second waveform type multiplexed in frequency.

8. The WTRU of claim 6, wherein the processor is configured to multiplex data carried on the data symbol and the set of reference signals of the second type to generate a multiplexing pattern, and
wherein the transceiver is further configured to transmit the data symbol using the multiplexing pattern.

9. The WTRU of claim 6, wherein the transceiver is further configured to transmit the data symbol using a multiplexing pattern that is common between the determined waveform type and another waveform type.

10. A method implemented in a wireless transmit/receive unit (WTRU), the method comprising:
determining a waveform type associated with a data symbol, wherein the waveform type is determined based on a predefined condition;
indicating the determined waveform type using a plurality of symbols in a slot, wherein the plurality of symbols carries a set of reference signals of a first type; and
transmitting the plurality of symbols and the data symbol, wherein the data symbol is transmitted in the slot, using the determined waveform type and after the plurality of symbols is transmitted.

11. The method of claim 10, wherein the predefined condition is any of a power limited condition or a mobility condition.

12. The method of claim 10, further comprising applying one or more time domain orthogonal cover codes to the set of reference signals.

13. The method of claim 12, wherein the set of reference signals includes two reference signals, wherein the one or more time domain orthogonal cover codes include a time domain orthogonal cover code being [1 1] or [1 −1], wherein [1 1] indicates a first waveform type and [1 −1] indicates a second waveform type.

14. The method of claim 10, wherein the determined waveform type is any of: an Orthogonal Frequency Division Multiplexing (OFDM) waveform, or a Discrete Fourier Transform (DFT)-spread OFDM (DFT-s-OFDM) waveform.

15. The method of claim 10, wherein the transmitting comprises transmitting a set of reference signals of a second type.

16. The method of claim 10, wherein the determined waveform type is a first waveform type multiplexed in time or a second waveform type multiplexed in frequency.

17. The method of claim 15, further comprising:
multiplexing data carried on the data symbol and the set of reference signals of the second type to generate a multiplexing pattern, and
wherein the transmitting comprises transmitting the data symbol using the multiplexing pattern.

18. The method of claim 15, wherein the transmitting comprises transmitting the data symbol using a multiplexing pattern that is common between the determined waveform type and another waveform type.
